(19) United States
(12) Patent Application Publication
(10) Pub. No.: US 2022/0048754 A1
(43) Pub. Date: Feb. 17, 2022

(54) CONSUMABLE-LIQUID DISPENSER

(71) Applicant: IMCP, LLC, Weddington, NC (US)

(72) Inventors: Ulrich Bernd SCHNACKE, Weddington, NC (US); Dov GLUCKSMAN, Winchester, MA (US); Michael MILLER, Tewksbury, MA (US); Andrew ROJEE, Derry, NH (US); Joseph GROSSI, Amesbury, MA (US)

(73) Assignee: IMCP, LLC, Weddington, NC (US)

(21) Appl. No.: 17/395,652

(22) Filed: Aug. 6, 2021

Related U.S. Application Data
(60) Provisional application No. 63/064,655, filed on Aug. 12, 2020.

(51) Int. Cl. B67D 1/08; B67D 1/14; B67D 1/04

(52) U.S. Cl. CPC B67D 1/0888; B67D 1/1405; B67D 1/0884; B67D 2210/00104; B67D 1/0431; B67D 2001/1483; B67D 1/0857

(57) ABSTRACT

A refrigerated consumable-liquid dispenser. A consumable-liquid container is carried in a covered refrigerated housing that includes a heat exchanger for maintaining consumable-liquid at a predetermined temperature which may be pre-selected depending on the type of consumable-liquid being carried. A dispensing tube provides a conduit for the consumable-liquid. To dispense the consumable-liquid, a pressure differential is produced in response to the user command, whereby the pressure on the liquid in the container is greater than the pressure at a dispensing port. User command may be achieved without physical contact with the consumable-liquid dispenser, for sanitary and health related considerations.

### RELATED APPLICATION

This application claims the benefit of U.S. Provisional Application Ser. No. 63/064,655, filed Aug. 12, 2020, entitled “Consumable-Liquid Dispenser,” which is incorporated herein by reference in its entirety.

### FIELD OF THE INVENTION

This invention generally relates to consumable-liquid dispensers. More specifically this invention relates to consumable-liquid dispensers that control the temperature of a consumable-liquid and may dispense a consumable-liquid without the consumer having to touch any surface of the dispenser.

### BACKGROUND OF THE INVENTION

Over the past decades, the popularity of coffee shops and quick-service-restaurants has increased dramatically, with different coffee shops and quick-service-restaurants operating in accordance with different business models. In some, the customer orders coffee with the additions of sweeteners or dairy products by the coffee shop and quick-service-restaurant personnel. In another popular business model to which this invention is particularly adapted, the customer obtains coffee in a cup and then moves to another part of the store to add dairy products and sweeteners. In many facilities using this latter business model, it is highly desirable that the dairy products be fresh for sanitary purposes and for overall taste.

This business model has generated certain requirements for dispensing such dairy-like products. For example, any such dispenser must refrigerate the dairy product or beverage in bulk rather than in containers for individual portions without the dairy product spoiling over time. Such dispensers must be easy to clean and easy to fill by the coffee shop and quick-service-restaurant personnel. Customers must find these dispensers easy to use without spilling the dairy product.

What is needed is a refrigerated consumable-liquid dispenser that preserves any consumable-liquid for prolonged periods of time to minimize spoilage and that is easy to use by consumers and to be serviced by the coffee shop and quick-service-restaurant personnel. Based on this need, Appliance Development Corporation developed a new beverage dispenser as disclosed in U.S. Pat. No. 7,975,881 which is incorporated herein in its entirety. Frieling U.S.A. Inc. has very successfully marketed this product under the trademark MILKCHILLER.

In early 2020, the world was struck with a Coronavirus known as COVID-19 and creating a worldwide pandemic. COVID-19 has caused countries throughout the world to lock down businesses and to “social distance.” There has been a major concern of transmission of COVID-19, including by touching items. Accordingly, use of the MILKCHILLER beverage dispenser has caused concerns by businesses such as STARBUCKS® as the numerous customers cannot use the typical milk or cream dispensing carafes without risking transmission of the virus by touching the carafe handles, having been contacted by others.

Accordingly, while the MILKCHILLER beverage dispenser requires minimum contact by the user, limited to pushing the delivery button, there is still a need for improvement to provide for dispensing of a dairy products and other consumable-liquids without the consumer touching the device.

### SUMMARY OF THE INVENTION

Therefore it is an object of this invention to provide a consumable-liquid dispenser that refrigerates a beverage, or other consumable-liquids, and dispenses the consumable-liquid in a controlled manner.

Another object of this invention is to provide a refrigerated consumable-liquid dispenser, that minimizes cleaning operations.

Another object of this invention is to provide a refrigerated consumable-liquid dispenser that is affordable for use in coffee shops, and quick-service-restaurants and like businesses.

Yet another object of this invention is to provide a refrigerated consumable-liquid dispenser that dispenses consumable-liquid without the consumer having to contact any surface to cause such consumable-liquid to be dispensed.

In accordance with one aspect of this invention, apparatus for dispensing the contents of a liquid container comprises a refrigerated housing for receiving the container. First and second ports are formed in the liquid container. A dispenser extends from the interior of the liquid container to a dispensing outlet at the exterior of the housing through the first port. Apparatus for producing a pressure differential and includes the second port whereby the pressure acting on the liquid in the container can be increased over the pressure at the dispensing outlet. Consequently, operation of this pressure differential apparatus dispenses liquid from the liquid container at the dispensing outlet.

In accordance with another aspect of this invention, the consumer may dispense consumable liquid without contacting any part of the dispenser, for the sake of, for example, avoiding infection from viruses and bacteria. A first proximity sensor responsive to the consumer's hand may be included, where, as long as the consumer's hand remains in proximity to the sensor consumable-liquid shall be dispensed; when the hand is removed the dispensing shall be stopped. As a further refinement, a second proximity sensor may be included, to determine that a receiving container is positioned underneath the dispensing outlet before any consumable-liquid can be dispensed.

In accordance with yet another aspect of this invention, a disposable apparatus for use with a liquid dispenser that receives a replaceable liquid container with an opening at its top portion and that directs the liquid from the container to a dispensing location in response to the generation of a pressure differential includes a stopper that attaches to the top portion adjacent the opening for defining first and second ports. A structure for directing liquid has a first tubular portion that extends through the first port into the liquid container. A second tubular portion extends exteriorly of the port structure to the dispensing location. The first and second tubular portions may be contiguous, if found to be beneficial. The second port connects to the pressure generating apparatus. Operating of the pressure generating apparatus thereby causes the liquid to flow from the liquid container through the liquid directing apparatus to the dispensing location.

In accordance with still another aspect of this invention, a disposable apparatus is adapted for use with a liquid dispenser that receives a replaceable liquid container with an opening at its top portion thereof. The disposable apparatus directs liquid from the container to a dispensing location in response to operation of a pressure generating means. The disposable apparatus includes a stopper that attaches to the top portion adjacent the opening for defining first and second ports therethrough. A liquid director conveys the liquid to a dispensing outlet. It has a first portion for extending through said first port into the liquid container and a second portion for extending exteriorly of said first port to the dispensing location. The first and second tubular portions may be contiguous, if found to be beneficial. The second port connects to the pressure generating means.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a perspective view of a prior art consumable-liquid dispenser;

FIG. 1A is a view like FIG. 1 shown with a consumer's hand positioned to activate the consumable-liquid dispenser and consumable-liquid being dispensed from the dispenser into a cup;

FIG. 2 is a rear view of the dispenser shown in FIG. 1;

FIG. 3 is a sectional view taken along lines 3-3 in FIG. 1;

FIG. 4 is a sectional view taken generally along lines 3-3 of FIG. 1 with a cover in an open position;

FIG. 5 is an exploded view of the dispenser shown in FIG. 1;

FIG. 6 is a simplified perspective view that depicts components of this invention;

FIGS. 7 and 8 are views of a disposable dispensing assembly useful in this invention;

FIG. 9 is a perspective view of a plug shown in FIG. 6;

FIG. 10 is a sectional view taken along lines 10-10 in FIG. 9;

FIG. 11 is a partial sectional view taken along lines 11-11 of FIG. 6;

FIG. 12 is a partial sectional view of the consumable-liquid dispensing apparatus taken along lines 12-12 in FIG. 3 to depict another useful feature of this invention;

FIG. 13 is a partial section view taken along lines 13-13 in FIG. 1 that depicts still another useful feature of this invention;

FIG. 14 is an enlarged portion of the partial section of FIG. 13;

FIG. 15 is a perspective view of a consumable-liquid dispensing apparatus constructed in accordance with the invention;

FIG. 16 is another perspective view of the consumable-liquid dispensing apparatus constructed in accordance with this invention as shown in FIG. 15;

FIG. 17 is a perspective view like FIG. 16 shown with a consumer's hand positioned to activate the consumable-liquid dispenser without contacting the apparatus and consumable-liquid being dispensed from the dispenser into a cup;

FIG. 18 is a simplified perspective view that depicts components of this invention;

FIG. 19 is a sectional view taken along lines 19-19 in FIG. 15;

FIG. 20 is a partial sectional view of FIG. 19; depicting a consumable-liquid container;

FIG. 21 is an enlarged partial sectional view of FIG. 20 with the tube removed; and

FIG. 22 is a perspective view of the consumable-liquid dispensing apparatus of FIG. 15 with its lid shown in an open position.

### DETAILED DESCRIPTION OF THE PREFERRED EMBODIMENTS

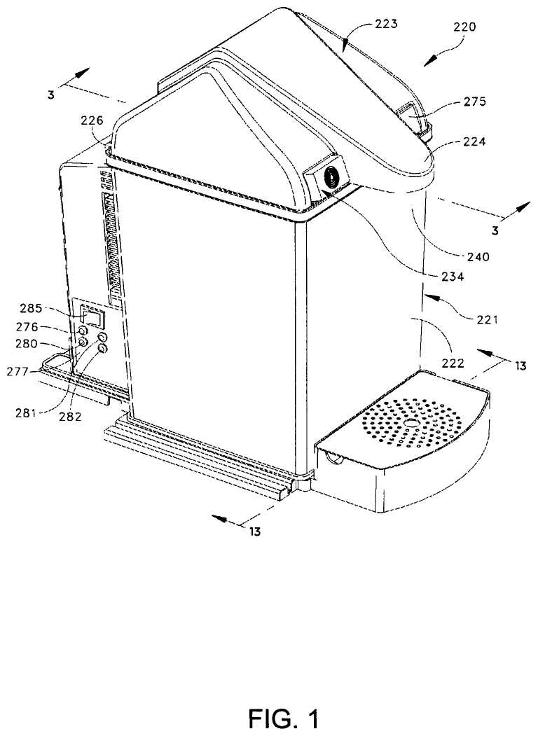

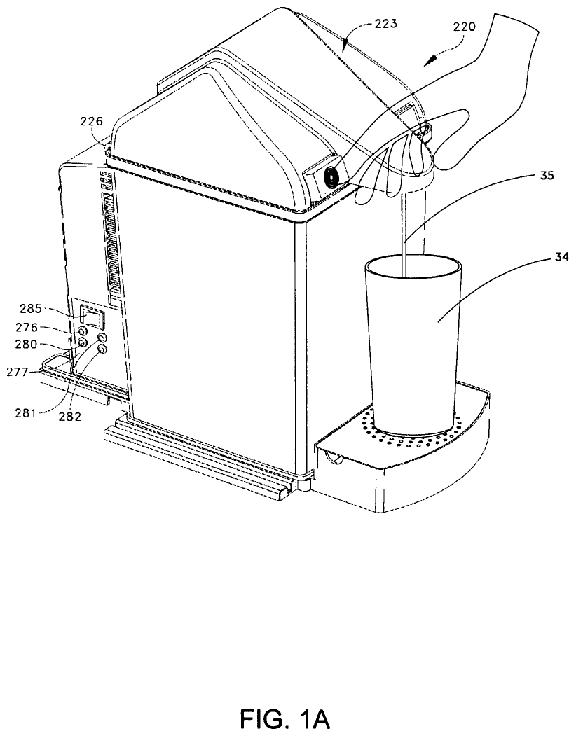

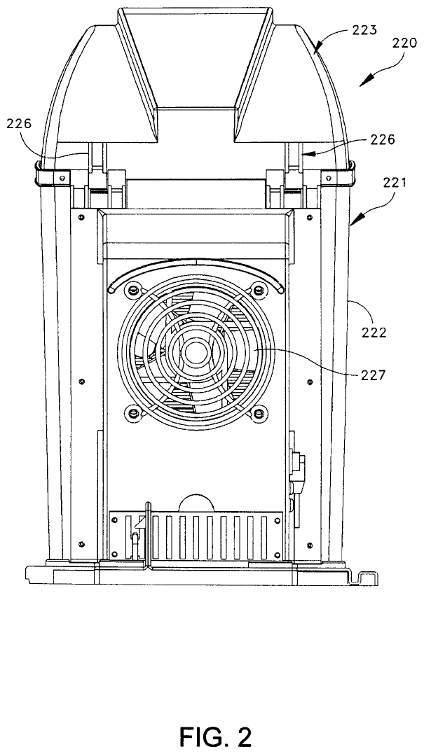

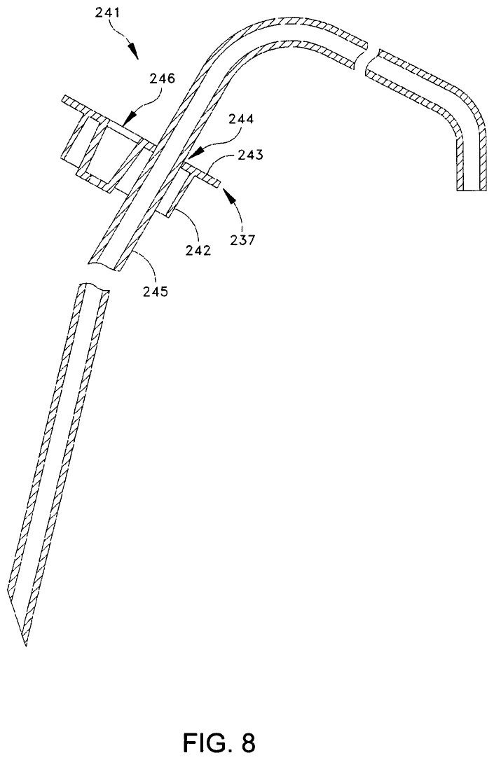

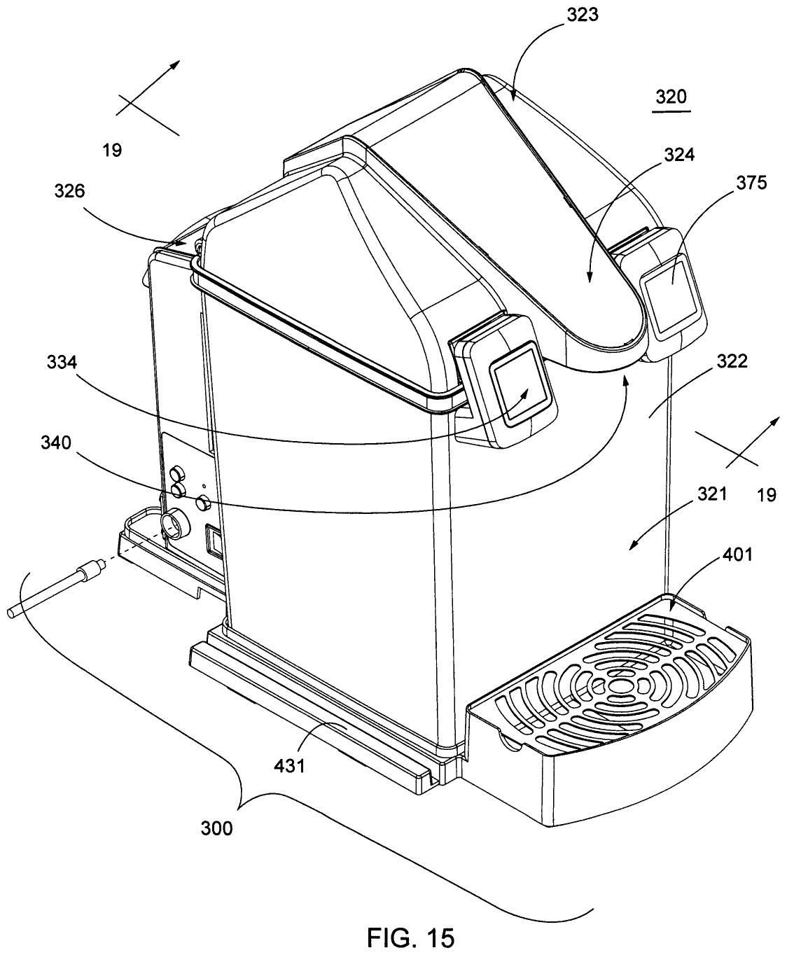

The consumable-liquid dispenser of the invention is shown in FIGS. 15-22. Features of the invention are described with respect to FIGS. 1-14, substantially similar to the invention described in U.S. Pat. No. 7,975,881. Thus, the present invention is an improvement over the '881 patent.

FIGS. 1 through 5 depict a consumable-liquid dispenser 220 that refrigerates a packaged consumable-liquid and facilitates the dispensing of that consumable-liquid. In one specific application, the consumable-liquid dispenser 220 may include a container or carton of milk for being dispensed into coffee or tea in a cup. It will become apparent that this invention can be implemented as a dispenser for a wide variety of liquids and containers, although its primary application will be for consumable-liquids that must be chilled to avoid spoilage.

The consumable-liquid dispenser 220 includes a covered refrigerated housing 221 that includes an outer housing 222 and cover 223. The cover 223 includes a cover body 224 that rotates about a cover body hinge 226. Liquid exits the consumable-liquid dispenser 220 at a dispensing position 240.

Still referring to FIGS. 1 through 5, the consumable-liquid dispenser 220 includes a base unit 31 with a drip basin assembly 301. The base unit 300 supports housing 221. The drip basin assembly 300 collects any consumable-liquid that may be spilled accidentally during use. The consumable-liquid dispenser 220 also contains indicia 275 for identifying the nature of the contents as, for example, milk, cream and half-and-half.

Referring now to FIG. 1A, in use the consumer positions a cup 34 below the dispensing position 240. Then the consumer presses the dispense button 234 to dispense the liquid in a stream 35 into the cup 34. When the consumer presses the dispense button 234, the consumable-liquid dispenser produces a pressure differential that forces the consumable-liquid from a container to be dispensed at the dispensing position 240. The consumable-liquid dispenser 220 comprises several assemblies to achieve this operation. These assemblies include the covered refrigerated housing 221 with subassemblies including the outer housing 222 and cover 223, a dispensing assembly that conveys the liquid from its container to the dispensing position 240, and a pressure differential enabling assembly that includes the dispense button 234. Each of the foregoing assemblies will now be discussed in detail.

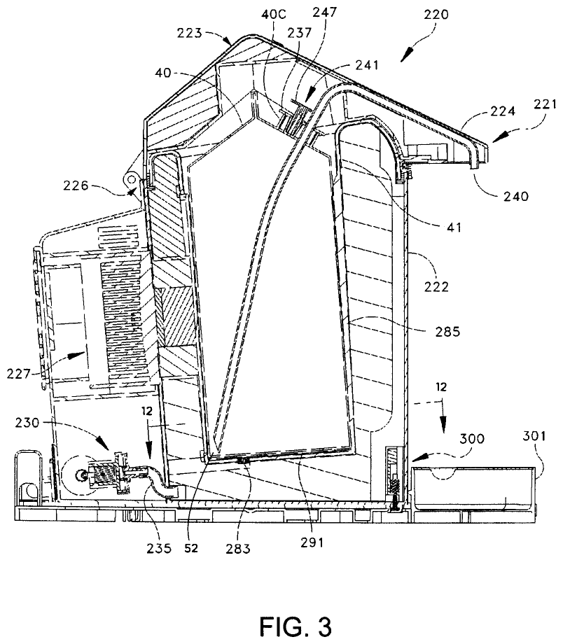

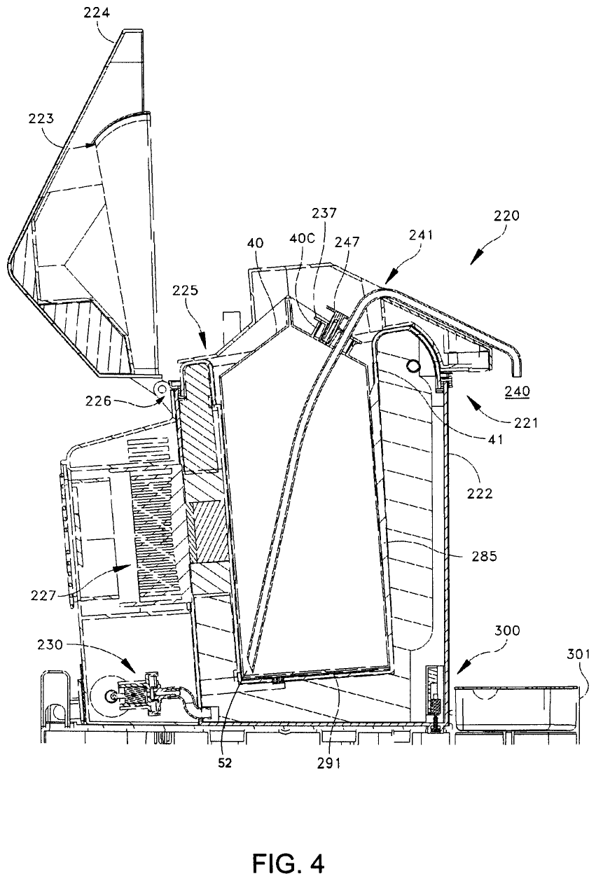

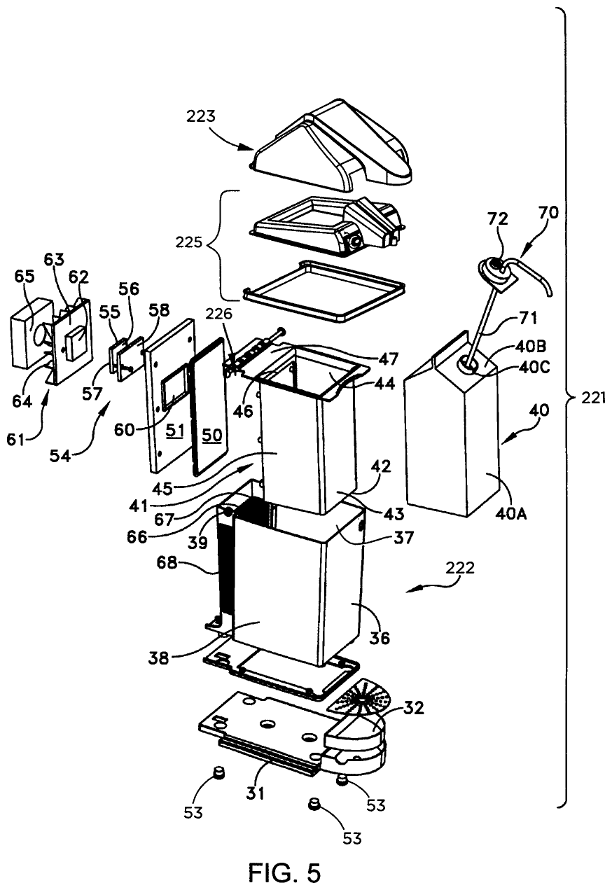

FIGS. 1 through 14 collectively depict an embodiment of an apparatus in the form of a consumable-liquid dispenser 220 for dispensing the contents of the liquid container in the form of a carton 40. As specifically shown in FIGS. 1 through 5, the consumable-liquid dispenser 220 includes a covered refrigerated housing 221 with an outer housing 222 and a cover 223 that includes an extension 224. In this embodiment the cover 223 provides a closure over an open top 225 (FIG. 4) of the outer housing 222. The cover 223 pivots on hinges 226 from a closed position shown in FIG. 3 counterclockwise to an open position as shown in FIG. 4. This allows the carton 40 to be inserted in an inner canted sleeve 41 (shown in FIG. 5) that lies against the cold side of a thermo-electric heat exchange assembly 227 based on thermoelectric element heat exchanger 54.

Referring now to FIG. 5, the covered refrigerator housing 221 receives a liquid container 40 and maintains the liquid at a predetermined temperature. In this specific embodiment, the outer housing 222 includes a front wall 36, a right-side wall 37, a left side wall 38 and a rear wall 39 that spans the right and left side walls 37 and 38.

This outer housing 222 supports a holder for a liquid container, such as a milk or cream carton 40, by means of an inner sleeve 41 with a bottom 42, a front wall 43, and right and left side walls 44 and 45. A rear frame 46 includes a top extension 47 that carries the hinge 226 for the cover 223. A thermally conducting plate 50 formed, for example, of aluminum mounts to a rear wall 51 to span and close the back of the sleeve 41. Collectively, the elements 41 through 50 form a closed bottom inner sleeve that receives a liquid container, namely the carton 40 in the embodiment shown in FIG. 5.

As will be apparent, in any specific implementation the sleeve 41 will be sized and configured to conform to a specific carton 40. In this embodiment, the carton 40 is a half-gallon carton and has a square bottom section 40A and roof-shaped top 40B with a spout 40C, normally closed by a cap that is not shown. In addition, the sleeve 41 may be canted, as shown in FIGS. 3 and 4 to lie along an axis that slopes from a forward position at the bottom to a rearward position at the top. Canting assures that the carton 40 forms a low area 52 that enables essentially all the liquid in the carton 40 to be dispensed. A portion of the weight of the carton, and its contents, will act to produce intimate contact between one wall of the carton 40 and the cold plate 50 to maximize heat transfer efficiency. Feet or supports 53 (FIG. 5) of different heights provide one means for canting the sleeve 41.

Still referring to FIG. 5, the cold plate 50 constitutes one element of a heat exchanger 54 that, in this embodiment includes a thermoelectric element located intermediate the outer housing 222 and the inner sleeve 41. The heat exchanger 54 maintains the contents of the carton 40 at a predetermined temperature that preserves the freshness of the liquid. More specifically, an electrically powered Peltier thermoelectric element 55 has a cold side 56 and a hot side 57. The cold side 56 mounts to a block 58 that extends through an access window 60 in the back wall 51 to contact the cold plate 50.

An air-cooled heat-sink 61 includes a body portion 62 that extends from a mounting plate 63 for a set of radial fins 64 to the hot side 57 of the thermoelectric element 55. A fan 65 establishes air flow from the exterior of the dispenser 220 through a back grate 66 and across the fins 64 to exit through right and left side grates 67 and 68.

As will now be apparent, when the thermoelectric element 55 is energized by an electric power supply, not shown but well known to those skilled in the art, heat transfers from the liquid in the carton 40 through the cold plate 50 and mounting block 58 into the thermoelectric element that constitutes current passing through the semiconductor converts the thermal energy into a flow of electrons which are converted back into thermal energy on the “hot” face 57 of the thermoelectric element. The fan 65 blows ambient air across the heat sink comprising the fins 64 to absorbing the thermal energy thereby completing the heat exchange process. As will also be apparent, the dispenser 220 may also include temperature sensors and circuitry for controlling the energization of the thermoelectric element 55 to maintain the liquid in the carton 40 at a predetermined temperature.

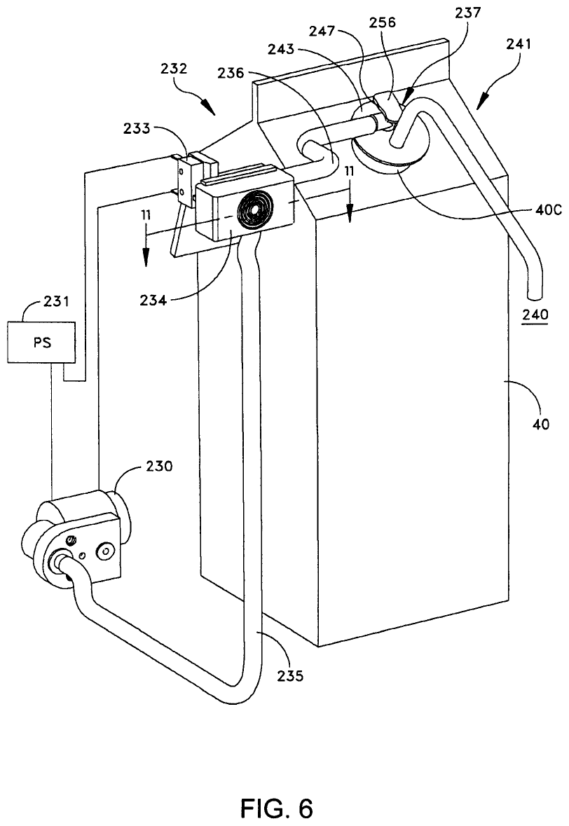

As shown particularly in FIGS. 3, 4 and 6 a pressure generator includes an electrically operated, motor-driven air pump 230 and enables the development of a pressure differential between the atmosphere and the pressure acting on the liquid surface within the carton 40. Referring to FIG. 6, the air pump 230 connects to an internal or external power supply 231. An electro-mechanical controller 232 controls the pressurization of the liquid in the carton and includes an electrical switch, such as a normally open micro switch 233, that connects one side of the power supply 231 to the pump 230 in a known manner. That is, when the micro switch is in a normal state, it has an open contact and the air pump 230 does not operate. However, depressing a mechanical control 234 closes the contacts in the micro switch 233. The power supply 231 energizes the air pump 230 providing air at increased pressures through an air passage in the form of a conduit or tubing 235 attached to the mechanical control 234 and another conduit or tubing 236 attached to a stopper 237.

Referring to FIG. 3, when the air pump 230 operates, the pressure inside the carton 40 increases. This increased pressure displaces the liquid in the carton through a dispensing assembly 241 to eject at a dispensing outlet 240.

The dispensing assembly 241, as particularly shown in FIGS. 3, 4 and 6 through 8, includes the stopper 237 that fits into the pouring spout 40C of the carton 40. The stopper 237 has a body 242 formed of an elastomer or like resilient material and an overlying top portion 243. The stopper body 242 seals against the interior of the pouring spout 40C. A first port 244 in the stopper 237 receives a J-shaped dispensing tube 245; a second port 246 receives a plug 247. The ports 244 and 246 define isolated passages through the stopper 242. When the stopper 242 is installed, it positions the inlet of the dispensing tube 245 at a low point in the carton 40.

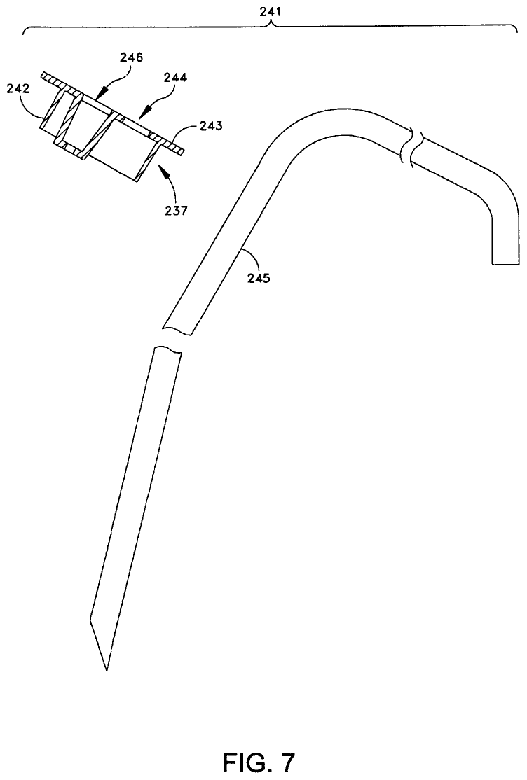

Referring particularly to FIGS. 3 through 10, the plug 247 has an L-shaped body 250 with an outlet passage 251 and inlet passage 252 formed in a vertical leg 253 and a horizontal leg 254, respectively. The horizontal leg 254 terminates in a fitting 255 that receives the tubing 236 shown in FIG. 6. In this embodiment the plug 247 is normally fixed to the tubing 236. Still referring to FIGS. 7 through 10, the vertical leg 253 is adapted to be inserted into the second port 246. A finger tab 256 at the top of the plug 247 facilitates the insertion and removal of the plug 246 from the stopper 237. Thus as air is pumped through the tubing 236, the inlet passage 252 and the outlet passage 251, into the sealed carton 40, the pressure bearing on the liquid in the container 40 increases and drives the liquid out of the carton 40 to be dispersed.

As will be apparent from FIGS. 6 through 8, the combination of the stopper 237 and the dispensing tube 245 constitute one embodiment of the disposable or removable dispensing assembly 241 that may be shipped as a preformed subassembly or as parts in a kit to be assembled on site. That is, a replacement dispensing assembly 241 could include the dispensing tube 245 and stopper 237 as discrete elements or as a subassembly. In another embodiment, it may be desirable for the plug 247 to constitute an additional component of the dispensing assembly 241. This feature allows the surfaces that contact the carton and liquid to be changed as a carton is replaced thereby to maximize sanitation.

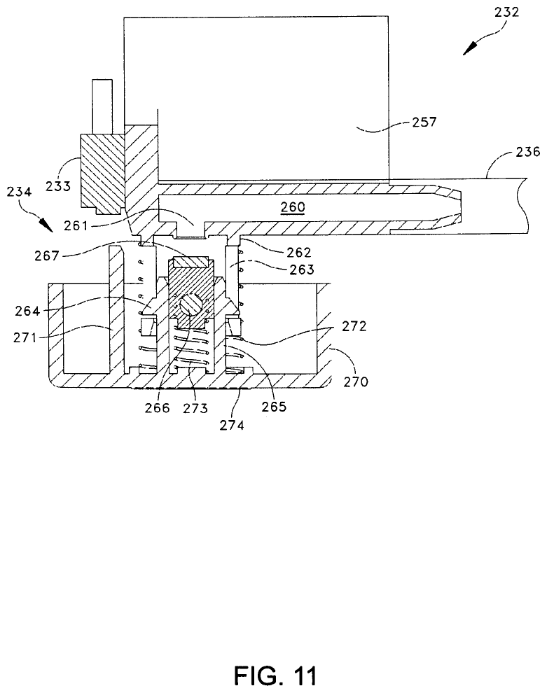

FIGS. 6 and 11 also depict the electro-mechanical controller 232 in greater detail. As specifically shown in FIG. 11, the electro-mechanical controller 232 includes a body portion 257 that carries the micro-switch 233 and that connects to the conduit 235 from the air pump 230 and to the conduit 236 that attaches to the plug 247. The body has an air passage 260 that exits into the conduit 236. A second passage, not shown, extends downwardly to define an air passage from the conduit 235. The body 257 also includes an exhaust port 261 that extends between a portion of the air passage 260 and the atmosphere. That is, the exhaust port 261, when unobstructed, exhausts the air passage 260 to atmosphere.

A pushbutton support structure 262 basically overlies the exhaust port 261 and contains a first set of slots 263 that capture wings 264 on a pushbutton body 265. A pin 266 rides in slots like the slots 263 but displaced 90 degrees.

As a result the pushbutton body 265 can reciprocate in the support structure 262 over a limited range, the maximum displacement of the pushbutton body 265 from the exhaust port 261 being defined by the interference between the wings 264 and the ends of the slots 263. The other end of the pushbutton body 265 carries a sealing pad 267 made of an elastomer or other like material. The body pushbutton body 265 also carries a cup-shaped actuator 270 with a micro-switch actuator 271 extending therefrom in alignment with the actuator of the micro-switch 233.

An outer spring 272 circumscribes the pushbutton support structure 262 to bias the pushbutton actuator 270 to the position shown in FIG. 11 such that the exhaust port 261 is open and the tip of the micro-switch actuator 261 is displaced from the micro-switch 233. An inner spring 273 between the pushbutton body 265 and the pushbutton actuator 270 biases the pushbutton body 265 toward the body portion 257.

In operation, after an individual places a cup proximate the dispensing location 240, such as shown in FIG. 1A, the individual depresses a pushbutton actuator finger pad 234. The pushbutton 270 thereby compresses the outer spring 272 until the pad 267 covers the exhaust port 261. At this point the micro-switch actuator 271 is spaced from the micro-switch 233. As the individual continues to depress the push-button actuator 270, the inner spring 273 compresses to perfect the seal at the exhaust port 261. Additional displacement causes the micro-switch actuator 271 to engage and activate the micro-switch 233 energizing the air pump 230. Now air is pumped through the conduit 235, the air passage 260, the conduit 236 and the passages in the plug 247 into the container 40. Liquid then is dispensed as the dispensing location 240.

The individual releases the pushbutton actuator 234 after dispensing the desired amount of liquid. Initially the micro-switch actuator 271 retracts, so the micro-switch 233 shuts down the air pump 230. At this instant, however, pressure remains in the carton 40. However, as the push button body 265 retracts further, the sealing pad 267 opens the exhaust port 261 whereupon air under pressure in the passage 260 vents to the atmosphere. The pressure within the carton 40 immediately reduces to atmospheric pressure terminating the flow of any further liquid through the dispensing tube 245. The effect is that any liquid in the dispensing tube 245 tends to flow back into the carton 40 given the differential heights at the dispensing location 240 and at the bottom of the carton 40. As will now be apparent, the pad 267, exhaust port 261 and related structures provide pneumatic control.

FIG. 1 depicts some other features, for example, FIG. 1 depicts a display panel 275 that operates in response to various inputs that occur through the activation of pushbuttons 276, 280, 281 and 282. In one specific embodiment, a pushbutton 276 on a control panel 277 connects to a computer control system that uses the display 275 as an output device. Actuating the pushbutton 276 changes the language that appears in the display 275. It is anticipated that the carton 40 may contain different consumable-liquids, such as various dairy products, ketchup, salad dressing, mustard, etc. Another push button 280 acts in conjunction with the computer control system to display the name of the consumable-liquid to be dispensed. Another pushbutton 281 provides a means of establishing default values for the system.

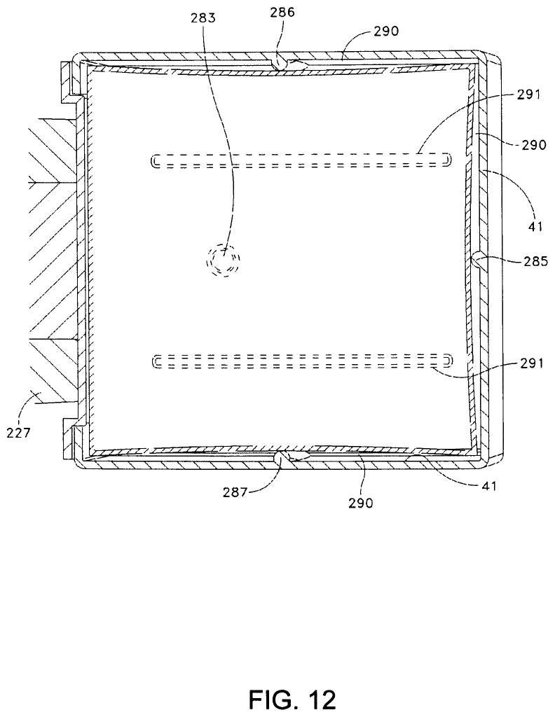

Still another pushbutton 282 could be included to display the temperature of the liquid. Specifically, as shown in FIG. 3, a temperature sensor 283, also shown in FIG. 12 is disposed in the bottom of the carton 40 and sleeve 41 to provide a temperature indication. FIG. 1 also depicts a power switch 285 for controlling the energization of the consumable-liquid dispenser 220. The implementation of these features will be apparent to those skilled in the art.

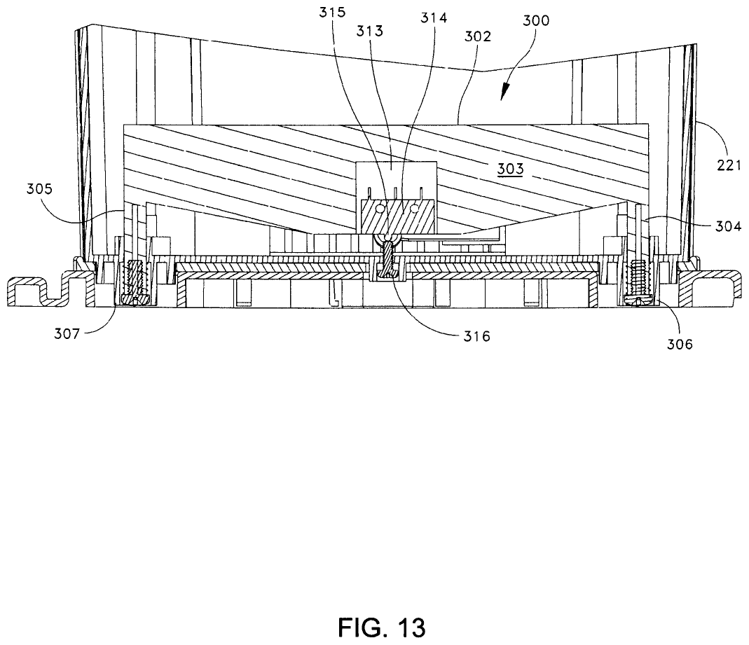

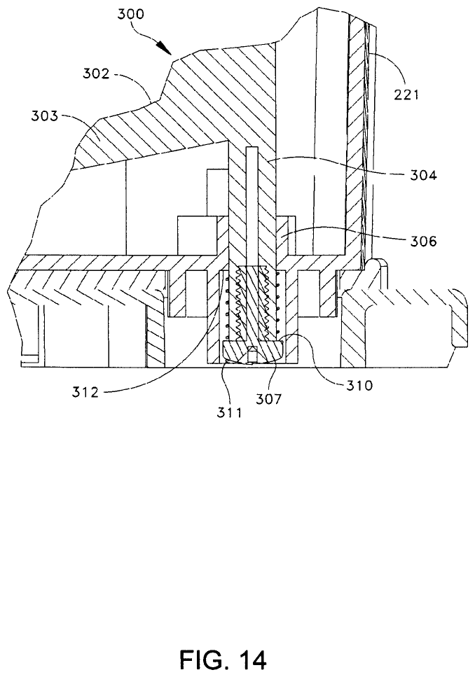

In another embodiment, the dispenser 220 of FIGS. 1 through 12 or the dispenser 320 of FIGS. 15 through 22 can incorporate an annunciator for alerting personnel to replenish the contents of the dispenser. Using the dispenser 220 as an example and referring to FIGS. 13 and 14, an annunciator 300 mounts within the outer housing 222 proximate a drip basin assembly 301. The annunciator includes a bridge 302 with a center span 303 and downwardly extending legs 304 and 305. Receptacles 306 and 307 in the base of the beverage dispenser receive the legs 304 and 305, respectively.

Looking at the structure surrounding the leg 304, as more clearly shown in FIG. 14, a machine screw 307 or like device provides a shoulder 310 that performs two functions. First, the shoulder 310 captures a spring 311 along with a shoulder 312 formed on the receiver 306. Second, the machine screw 307 prevents the leg 304 from exiting the top of the receiver 306.

When the carton 40 is full, the combined weights of the beverage dispenser and carton drive the bridge downward. As the weight of the carton 40 reduces, eventually the springs on the legs 304 and 305, like the spring 311, elevate the legs 304 and 305 and the integral bridge span 303.

Referring again to FIG. 13, the span 303 includes a central cavity 313 that carries a microswitch 314 with an actuator 315. The base carries a calibrating screw 316. The calibrating screw 316 is positioned, vertically in FIG. 13, such that the actuator 315 just engages the end of the calibrating screw 316 when a carton needs replacement. Normally a full carton produces a force on the springs that is greater than the force that will exist when replenishment is required. As the weight reaches that point, the springs will elevate the span 303 until actuator 315 shifts state based on a reduction of pressure exerted by the calibrating screw 316. The state of the microswitch 314 then indicates whether the carton is sufficiently full or needs to be replaced. As will be apparent, the calibrating screw 316 can be adjusted either at a factory or by the user to fine tune the set point which causes the annunciator to indicate the need for a replacement carton. Further details of the annunciator circuit are not included as the implementation of any number of annunciator variations that respond to the condition of a switch, like the microswitch 314 are well known to those skilled in the art.

FIGS. 15 through 17 reference the present invention of a consumable-liquid dispenser 320 that refrigerates a consumable-liquid contained in a reusable container 70 and facilitates the dispensing of that consumable-liquid and providing that the consumer does not contact any surface of the dispenser while causing consumable-liquid to be dispensed. In such devices the consumable-liquid dispenser 320 may include a container of milk for being dispensed into coffee or tea in a cup. The invention uses certain aspects of the apparatus of FIGS. 1-14.

The consumable-liquid dispenser 320 includes a covered refrigerated housing 321 that includes an outer housing 322 and cover 323. The cover 323 rotates about a cover body hinge 326. Liquid exits the consumable-liquid dispenser 320 at a dispensing position 340.

Still referring to FIGS. 15 through 17, the consumable-liquid dispenser 320 includes a base unit 431 with a drip basin assembly 401. The base unit 300 supports housing 321. The drip basin assembly 401 collects any consumable-liquid that may be spilled accidentally during use.

The consumable-liquid dispenser 320 also contains indicia 375 for identifying the nature of the contents as, for example, milk, cream and half-and-half. It also contains a pressure differential enabling assembly that may include at least one sensor assembly. A first sensor assembly 334 for sensing the presence of the consumer hand, it may also include a second sensor assembly (not shown) for detecting the presence of a container into which consumable-liquid is to be dispensed.

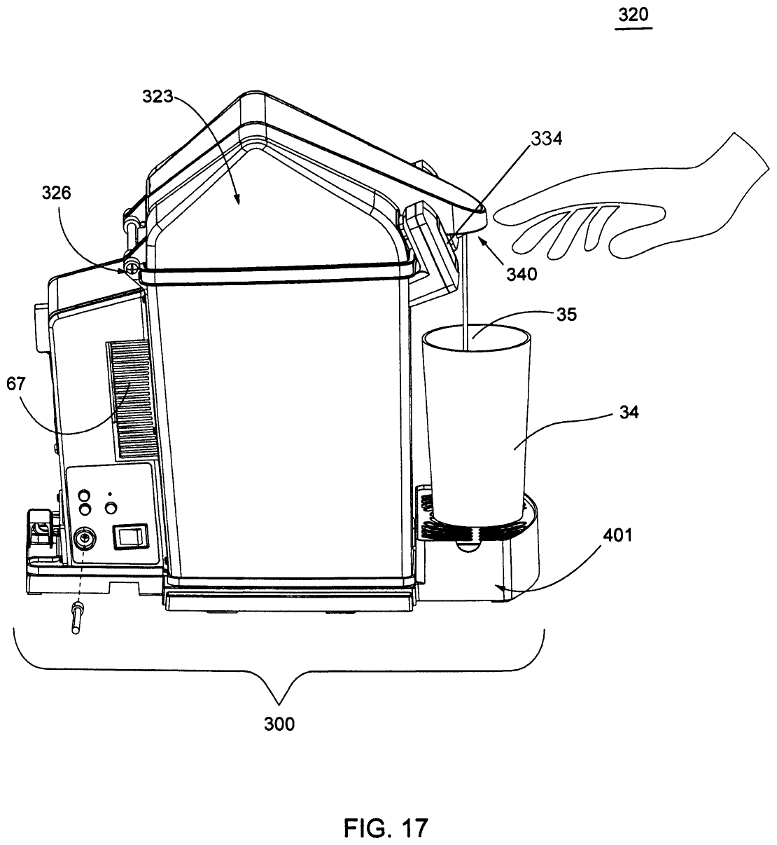

Referring now to FIG. 17, in use the consumer positions a cup 34 under the dispensing position 340 where the presence of the cup may be sensed by the second sensor assembly. When the consumer's hand or finger is sensed by first sensor assembly 334, the consumable-liquid dispenser produces a pressure differential that forces the consumable-liquid from a container 70 to be dispensed at the dispensing position 340.

When the consumer's hand or finger are removed from the first sensor assembly 334 after having dispensed a desired amount, the first sensor assembly 334 causes the pressure differential to end thereby to terminates the flow of liquid. Also, when the cup 34 is removed the second sensor 335 causes the pressure differential to end thereby to terminates the flow of liquid.

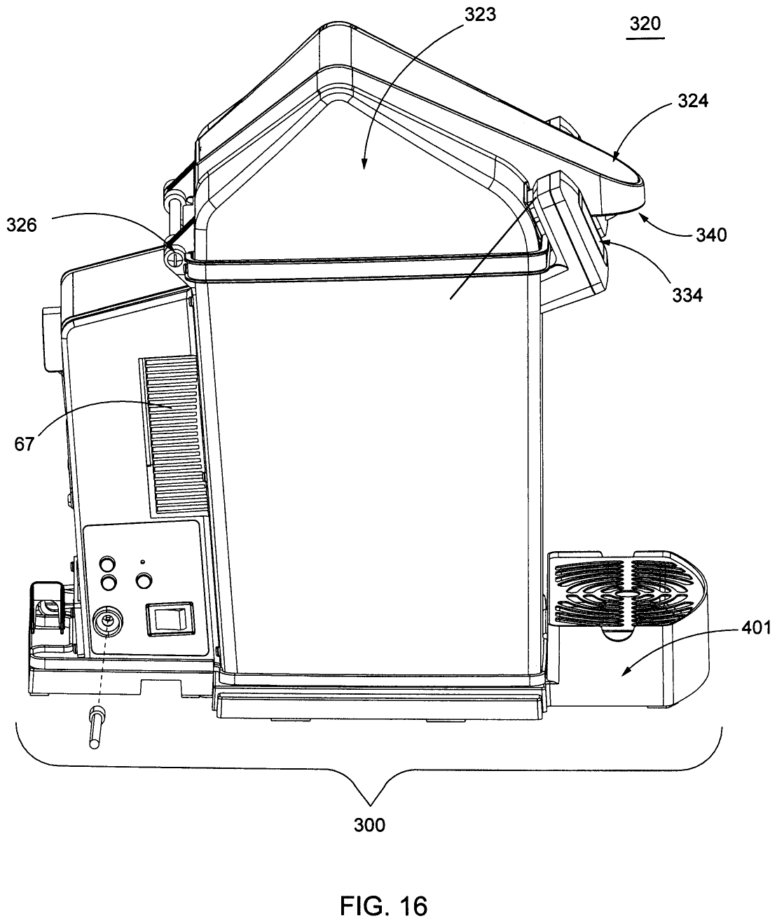

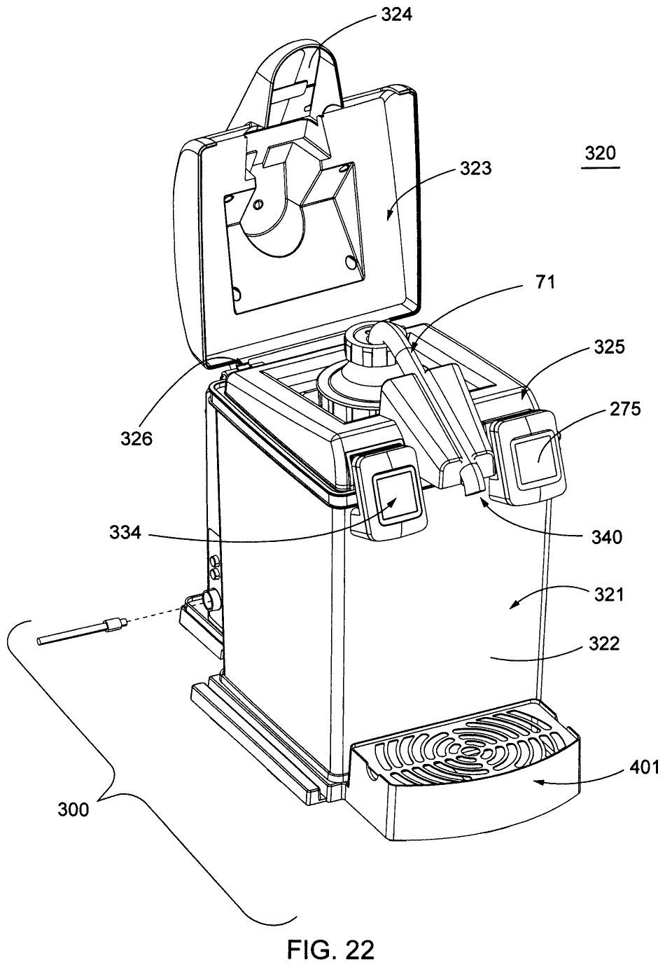

FIGS. 15 through 22 collectively depict an embodiment of an apparatus according to the invention in the form of a consumable-liquid dispenser 320 for dispensing the contents of the liquid container 70. As specifically shown in FIGS. 15 through 17 and FIG. 19, the consumable-liquid dispenser 320 includes a covered refrigerated housing 321 with an outer housing 322 and a cover 323 that includes an extension 324. In this embodiment the cover 323 provides a closure over an open top 325 (FIG. 22) of the outer housing 322. The cover 323 pivots on hinges 326 from a closed position shown in FIGS. 15 and 16 counterclockwise to an open position as shown in FIG. 22. This allows the container 70 to be inserted in an inner canted sleeve 41 that lies against the cold side of a thermo-electric heat exchanger 327 comprising a thermoelectric element 55.

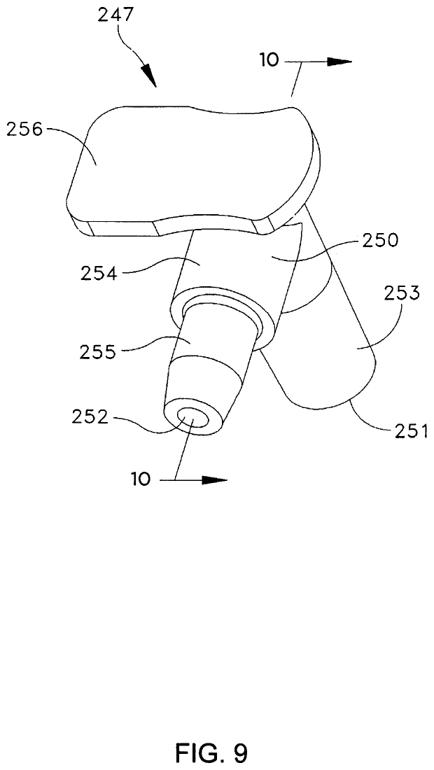

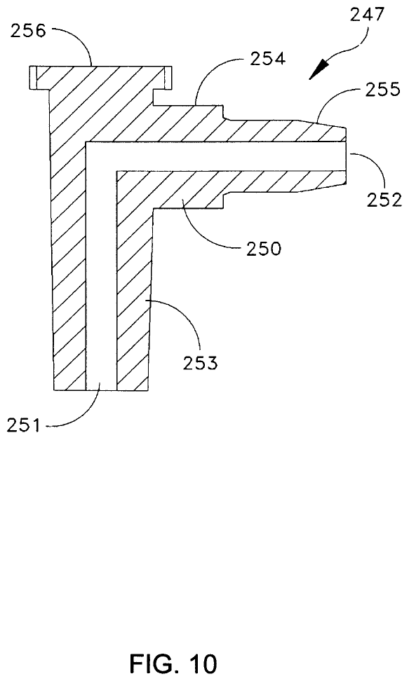

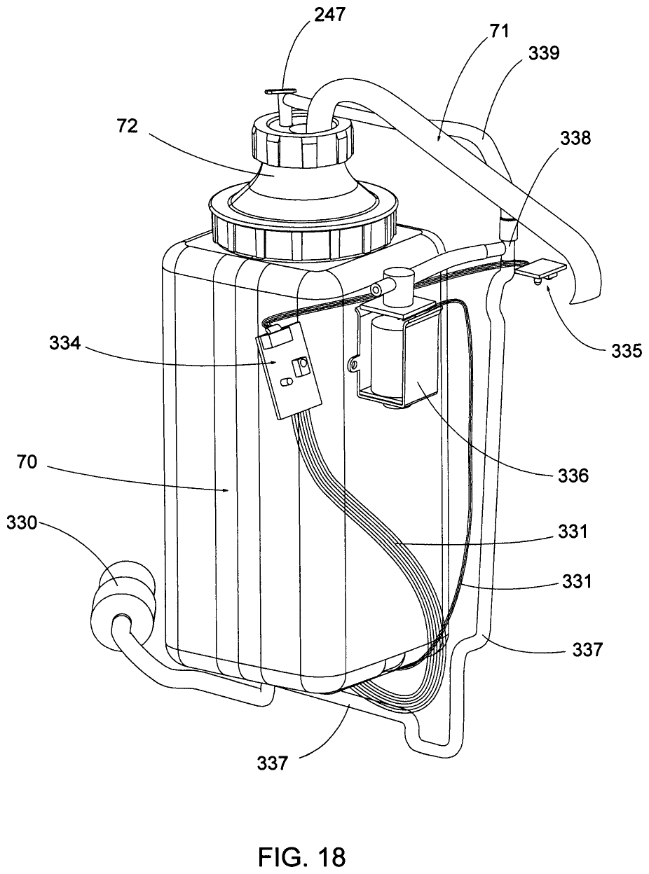

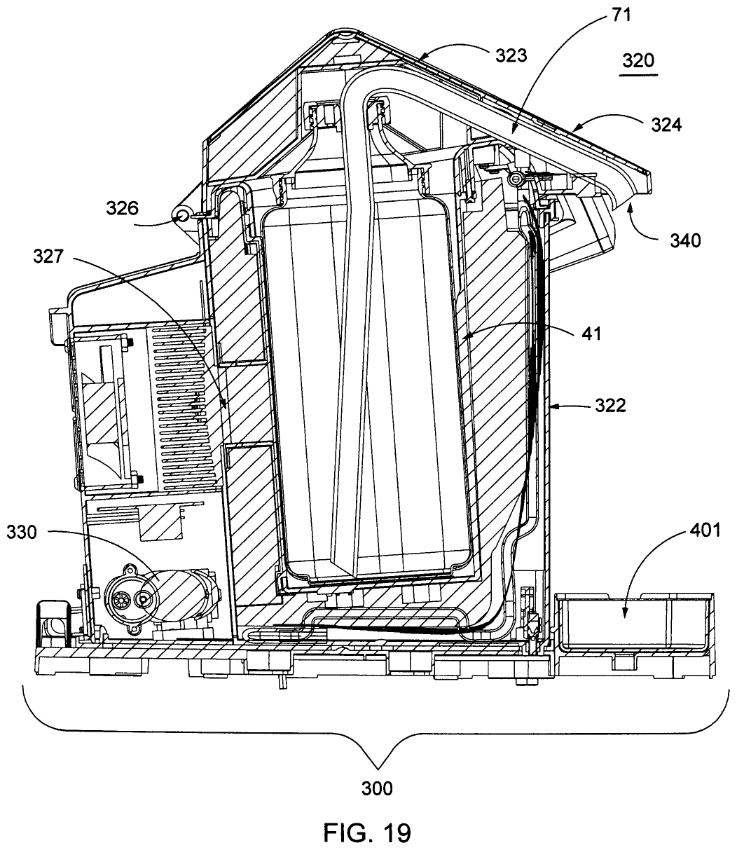

As shown particularly in FIGS. 15 and 19 a pressure generator includes an electrically operated, motor-driven air pump 330 and enables the development of a pressure differential between the atmosphere and the pressure acting on the liquid surface within the container 70. Referring to FIG. 18, which illustrates some details of the electro-mechanical controller that controls the pressurization and depressurization of the liquid in the container 70. The controller includes a first sensor assembly 334, a second sensor assembly 335, a normally-open solenoid valve 336, electrical wires 331 for connecting the various operating elements and sensors to an electronic board (not shown), pre-programmed in accordance with the specific requirements of the system and an air pump 330 that connects to an internal or external power supply (not shown). When first and second sensors are activated they signal to the electronic board which energizes the air pump 330, concurrently energizing the solenoid valve 336 (causing it to shut) providing air at increased pressures through an air passage in the form of a conduit or tubing 337 connected via a three-port junction 338 to another conduit or tubing 339 attached to a plug 247 (FIGS. 9 and 10) connected through a pressure fit to stopper 78.

When the air pump 330 is turned on, the pressure inside the container 70 increases. This increased pressure displaces the liquid in the container through a dispensing tube 71 to eject at a dispensing outlet 340. When first and second sensors are deactivated the air pump 330 is deenergized and the solenoid valve is deenergized and returns to its normally-open position, the pressure inside the container 70 decreases, as the air escapes to atmosphere, ending the dispensing of liquid.

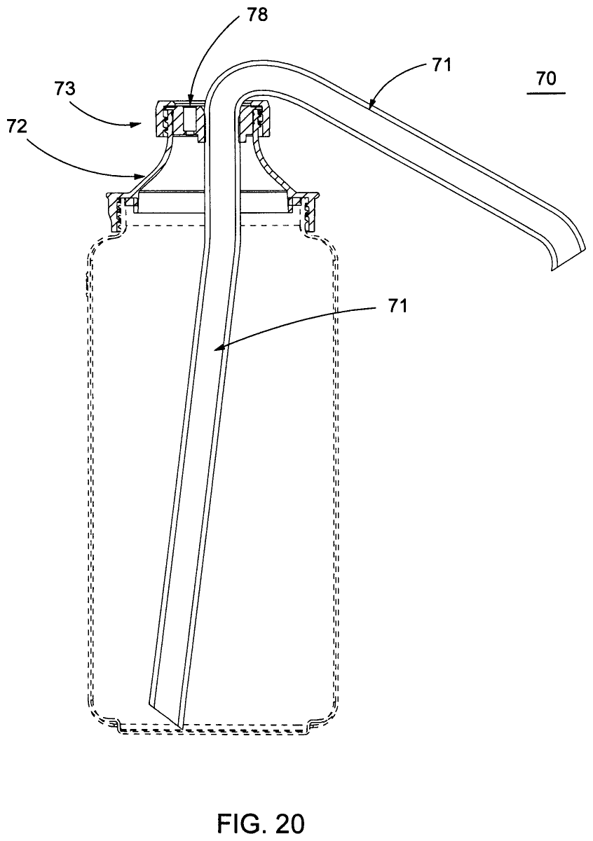

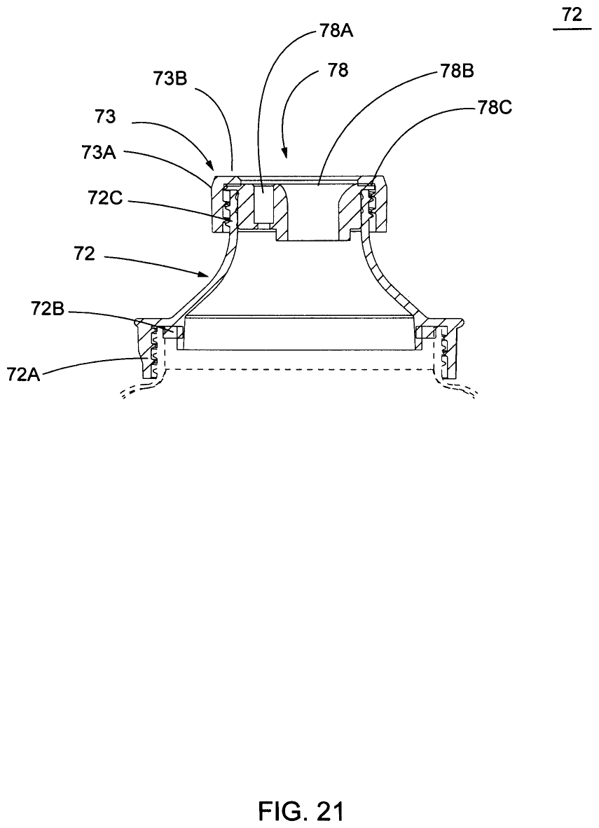

In instances where consumable-liquids of higher viscosity, such as yogurt, ketchup, mustard are to be dispensed, a higher pressure will have to be generated within the container 70, where such higher pressure will require that the stopper be secured by mechanical means instead of by means of a friction fit (as shown in FIGS. 3-5). FIGS. 18-22 show a preferred embodiment that may provide such pressure resistant securement to the stopper. FIGS. 20 and 21 show the container 70 with its cap 72, comprising lower inward facing threaded collar 72A for engaging a thread at the top of the container 70, also including a gasket 72B, an outward facing threaded portion 72C at the upper end of the cap provides securement to the stopper through a threaded ring 73, including a threaded cylindrical portion 73A and an inwardly projecting flange 73B. The inner diameter of the flange is smaller than the outer diameter of the stopper 78 to secure it in place, when tightened in place. Stopper 78 includes a body portion a small port 78A to receive the stopper 247 in a tight fit, and large port 78B to receive the dispensing tube 71, and a flange portion 78C to prevent the stopper from falling through the upper end of the cap. The stopper 78 is made of an elastomeric material, with the appropriate durometer to enhance its sealing properties and the low friction coefficient to ensure that the stopper and the tube are sealeably secured within the port of the stopper.

It will now be apparent that this invention can be implemented with diverse structures. Two specific structures have been shown. The specific implementations may be modified by relocation of the disclosed or equivalent structures. While the device has been disclosed as a liquid chilling and dispensing apparatus, it is readily adapted to be a liquid heating and dispensing apparatus by reversing the polarity of the electrical leads feeding the Peltier device and making other minor changes which will be apparent to those of ordinary skill in the art. Thus, the exemplary embodiments herein disclosed are not intended to be exhaustive or to unnecessarily limit the scope of the invention. The exemplary embodiments were chosen and described to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A dispenser for dispensing the contents of a consumable-liquid product from a container with a spout from a dispensing outlet at the exterior of said dispenser wherein the user does not contact any surface of the dispenser while causing the consumable-liquid product to be dispensed from the dispensing outlet, said dispensing apparatus comprising-
a covered refrigerated housing means for receiving the container and including means for constraining deformation of the container,
a first sensor assembly for sensing the presence of the user's hand and optionally a second sensor assembly for detecting the presence of a vessel into which the consumable-liquid product is to be dispensed,
a port means detachably connected to the container at the spout for forming first and second ports into the container through the spout,
dispensing means for forming a closed path extending from the interior of the container through said first port to the dispensing outlet at the exterior of said housing, and
pressure differential enabling means attached to said housing remotely from said port means and separated and isolated from said dispensing means for increasing the pressure acting on the consumable-liquid product in the container through said second port to a value above the pressure at said dispensing outlet whereby operation of said pressure differential enabling means increases the pressure in the constrained container and on the consumable-liquid product therein to cause force consumable-liquid product to be transferred from the container through said dispensing means to the dispensing outlet thereby to emerge from the spout without contacting said pressure differential enabling means, and
wherein, in use, the user positions the drinking vessel under the dispensing outlet where the vessel may be sensed by the optional second sensor assembly and the user's hand is placed near the first sensor assembly which is sensed by said first sensor assembly and the apparatus produces a pressure differential from the container causing the consumable-liquid product to be dispensed at the dispensing outlet into the vessel.

2. The dispenser of claim 1 further comprising both said first sensor assembly and said second sensor assembly.

3. The dispenser of claim 2 wherein when the vessel is removed from the dispenser said second sensor assembly is adapted to cause the pressure differential to end thereby terminating the flow of the consumable-liquid product.

4. The dispenser of claim 1 further comprising a preprogrammed electronic board.

5. The dispenser of claim 1 wherein said housing means includes an outer housing and said constraining means includes an inner sleeve for receiving the container.

6. The dispenser of claim 5 wherein said outer housing has a rear wall and said inner sleeve is canted to position the top of said inner sleeve closer to said outer housing rear wall than a bottom of said inner sleeve.

7. The dispenser of claim 5 wherein said inner sleeve has a thermally conducting wall for contacting the container and said housing means includes heat exchanging means intermediate said outer housing and said inner sleeve for cooling said thermally conducting wall.

8. The dispenser of claim 7 wherein said heat exchanger includes:
a thermoelectric refrigeration unit and a cold plate connected to one side thereof, said cold plate being in contact with said inner sleeve rear wall,
a heat sink connected to the other side of said thermoelectric refrigeration unit,
a fan, and
flow direction means of said housing for facilitating the flow of air produced by said fan across said heat sink.

9. The dispenser of claim 1 additionally including an annunciator connected to said housing that announces the need for replacing the container.

10. The dispenser of claim 1 wherein dispensing means includes a dispensing tube extending through said first port from the bottom of the container to the dispensing outlet and said housing means includes means for positioning said dispensing tube exteriorly of said housing means.

11. The dispenser of claim 10 wherein said dispensing tube and said port means form a removable subassembly.

12. The dispenser of claim 10 wherein said dispensing tube has an inverted J-shape with an elongated leg extending through said first port and a reverse portion that interacts with said positioning means whereby said dispensing tube directs consumable-liquid downwardly at said dispensing outlet.

13. The dispenser of claim 1 wherein said pressure differential means includes an air pump for producing the differential pressure and air passage means for conveying air under pressure from said air pump to said second port.

14. The dispenser of claim 13 additionally including control means attached to said air passage means and said air pump for controlling the pressurization of the liquid in the container.

15. The dispenser of claim 14 wherein said air pump includes an electric motor that connects to a power supply and said control means includes electric control means for controlling the energization of said electric motor from the power supply and pneumatic control means for controlling the flow of air through said air passage means.

16. The dispenser of claim 15 wherein said electric control means includes a switch connected between the power supply and said electric motor and said pneumatic control means includes an exhaust port through said air passage means and wherein control means includes a push button actuator which, when activated, closes said air passage means exhaust port and closes said switch thereby to activate said air pump.

17. A dispenser for chilled consumable-liquids in a liquid container with a spout wherein the liquid is subject to spoiling, wherein the user does not contact any surface of the dispenser while causing the consumable-liquid to be dispensed from a dispensing outlet of the dispenser, the dispenser comprising-
an outer housing,
a first sensor assembly for sensing the presence of the user's hand and optionally a second sensor assembly for detecting the presence of a vessel into which the consumable-liquid is to be dispensed,
a thermoelectric heat exchanger in said housing having a cold side and a hot side wherein a heat sink attaches to the hot side and a fan directs air across the heat sink,
a sleeve in said housing that receives the liquid container and constrains the deformation thereof, a portion of the liquid container being in contact with said cold side thereby to chill the consumable-liquid in the liquid container,
a stopper that engages the liquid container spout and closes the opening through the spout, said stopper including pressurization and dispensing tube ports therethrough,
an air pump and conduit that direct air under pressure through said pressurization port thereby to increase the pressure in the liquid container and on the liquid, and
a dispensing tube separated and isolated from said air pump and conduit for forming a closed path from a bottom portion of the liquid container through said dispensing tube port to the spout whereby operation of said air pump forces the consumable-liquid in the liquid container to be dispensed from said dispenser through a dispensing outlet thereby to emerge from the spout without contacting said air pump,
wherein, in use, the user positions the drinking vessel under the dispensing outlet where the vessel may be sensed by the optional second sensor assembly and the user's hand is placed near the first sensor assembly which is sensed by said assembly and the apparatus produces a pressure differential from the liquid container causing the consumable-liquid to be dispensed at the dispensing outlet into the drinking vessel.

18. The dispenser of claim 17 further comprising both said first sensor assembly and said second sensor assembly.

19. The dispenser of claim 18 wherein when the drinking vessel is removed from the dispenser said second sensor assembly is adapted to cause the pressure differential to end thereby terminating the flow of the consumable-liquid.

20. The dispenser of claim 17 wherein said sleeve is canted in said outer housing and said dispensing tube extends to the lowest portion of the liquid container.
